(19) United States
(12) Patent Application Publication
(10) Pub. No.: US 2025/0246648 A1
(43) Pub. Date: Jul. 31, 2025

(54) FUEL CELL

(71) Applicant: TOYOTA JIDOSHA KABUSHIKI KAISHA, Toyota-shi Aichi-ken (JP)

(72) Inventor: Kohsei YOSHIDA, Gotemba-shi Shizuoka-ken (JP)

(73) Assignee: TOYOTA JIDOSHA KABUSHIKI KAISHA, Toyota-shi Aichi-ken (JP)

(21) Appl. No.: 19/017,968

(22) Filed: Jan. 13, 2025

(30) Foreign Application Priority Data
Jan. 30, 2024 (JP) 2024-011724

(51) Int. Cl. H01M 8/04089; H01M 8/0273

(52) U.S. Cl. CPC H01M 8/04089; H01M 8/0273

(57) ABSTRACT

A fuel cell is configured to suppress the inhibition of gas supply to the power generation unit. A fuel cell, wherein the fuel cell comprises at least a pair of separators and a resin frame; wherein each of the pair of separators has at least one manifold; wherein the pair of separators are adhered via the resin frame; wherein the resin frame has an adhesive layer on both sides; wherein the resin frame has a manifold opening corresponding to the manifold and a power generation opening corresponding to a power generation unit; wherein an inner diameter of the manifold opening is smaller than that of the manifold; and wherein the resin frame has at least one ventilation portion between the manifold opening and the power generation opening.

### CROSS-REFERENCE TO RELATED APPLICATIONS

This application is based upon and claims the benefit of priority of the prior Japanese Patent Application No. 2024-011724, filed on Jan. 30, 2024, the entire contents of which are incorporated herein by reference.

### TECHNICAL FIELD

The disclosure relates to a fuel cell.

### BACKGROUND

Various studies have been proposed for fuel cells (FC) as disclosed in Patent Document 1.

Patent Document 1: Japanese Patent Application Laid-Open (JP-A) No. 2016-018703

Patent Document 1 discloses a fuel cell in which a pair of separators are fixed with an adhesive. In general, the manifold portions of the pair of separators are shaped such that the resin frame, which is a sealing member in the cell, protrudes beyond the end of the separators to prevent short-circuiting.

However, since the gas flows vigorously in the manifold, when the sealing member used has adhesiveness, the sealing member is vent, and the gas flow path from the manifold to the power generation unit is blocked; therefore, the supply of the gas to the power generation unit may be inhibited.

### SUMMARY

The disclosure was achieved in light of the above circumstances. An object of the disclosure is to provide a fuel cell configured to suppress the inhibition of gas supply to the power generation unit.

That is, the present disclosure includes the following embodiments.
<1> A fuel cell,
   wherein the fuel cell comprises at least a pair of separators and a resin frame;
   wherein each of the pair of separators has at least one manifold;
   wherein the pair of separators are adhered via the resin frame;
   wherein the resin frame has an adhesive layer on both sides;
   wherein the resin frame has a manifold opening corresponding to the manifold and a power generation opening corresponding to a power generation unit;
   wherein an inner diameter of the manifold opening is smaller than that of the manifold; and
   wherein the resin frame has at least one ventilation portion between the manifold opening and the power generation opening.
<2> The fuel cell according to <1>,
   wherein the ventilation portion is configured to vent a gas regardless of whether or not the resin frame is deformed.
<3> The fuel cell according to <1>,
   wherein gas ventilation through the ventilation portion is prevented when the resin frame is in an undeformed state, and gas ventilation through the ventilation portion is allowed when the resin frame is in a deformed state.
<4> The fuel cell according to <1> or <2>,
   wherein a shape of the ventilation portion is at least one shape selected from the group consisting of a circular shape, a horizontally elongated shape, an oblique shape, a vertically elongated shape, and a polygonal shape.

The fuel cell of the present disclosure is configured to suppress the inhibition of the gas supply to the power generation unit.

### BRIEF DESCRIPTION OF THE DRAWINGS

In the accompanying drawings,

FIG. 1 is a schematic cross-sectional view showing an example of the gas inlet manifold and its periphery of the fuel cell of the present disclosure;

FIG. 2 is a schematic plan view showing an example of the resin frame in the gas introduction portion of the fuel cell of the present disclosure;

FIG. 3 is a schematic plan view showing another example of the resin frame in the gas introduction portion of the fuel cell of the present disclosure;

FIG. 4 is a schematic plan view showing another example of the resin frame in the gas introduction portion of the fuel cell of the present disclosure;

FIG. 5 is a schematic plan view showing another example of the resin frame in the gas introduction portion of the fuel cell of the present disclosure; and

FIG. 6 is a schematic plan view showing another example of the resin frame in the gas introduction portion of the fuel cell of the present disclosure.

### DETAILED DESCRIPTION

Hereinafter, the embodiments of the present disclosure will be described in detail. Matters that are required to implement the present disclosure (such as common a fuel cell structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In addition, dimensional relationships (length, width, thickness, and the like) in the drawings do not reflect actual dimensional relationships.

In the present disclosure, a gas supplied to the anode of the fuel cell is a fuel gas (anode gas), and the gas supplied to the cathode of the fuel cell is an oxidant gas (cathode gas). The fuel gas is a gas mainly containing hydrogen, and may be hydrogen. The oxidant gas is a gas containing oxygen, and may be oxygen, air, or the like. In the present disclosure, the fuel gas and the oxidizing gas are collectively referred to as a reaction gas or a gas.

In the present disclosure, there is provided a fuel cell,
wherein the fuel cell comprises at least a pair of separators and a resin frame;
wherein each of the pair of separators has at least one manifold;
wherein the pair of separators are adhered via the resin frame;
wherein the resin frame has an adhesive layer on both sides;
wherein the resin frame has a manifold opening corresponding to the manifold and a power generation opening corresponding to a power generation unit;
wherein an inner diameter of the manifold opening is smaller than that of the manifold; and
wherein the resin frame has at least one ventilation portion between the manifold opening and the power generation opening.

Since gas is supplied to each cell without shortage, a large amount of gas flows vigorously in the manifold. Therefore, a force is generated in which the gas pushes down the resin frame.

In a resin frame having a thermoplastic heat-welded layer on both surfaces of the conventional resin frame, the heat-welded layer softens when melted at high heat (for example, 160° C. or higher) during cell formation, but the heat-welded layer is hard in the operating temperature range of the fuel cell. Therefore, the resin frame does not block the gas flow path between the flexible resin frame and the separator due to the force of the gas.

However, in a resin frame having an adhesive layer on both surfaces thereof, since the adhesive layer is soft in the operating temperature region of the fuel cell, the resin frame may be bent due to the flow of gas, and the gas flow path between the resin frame and the separator may be blocked.

In the present disclosure, in the gas introduction portion from the manifold of the resin frame, the resin frame is bent by providing a ventilation portion for preventing the blockage in a part of the resin frame, even if it is bent, it is possible to supply the gas from the manifold to the power generation unit by the ventilation portion, it is possible to reduce the decrease in the gas supply amount to the power generation unit.

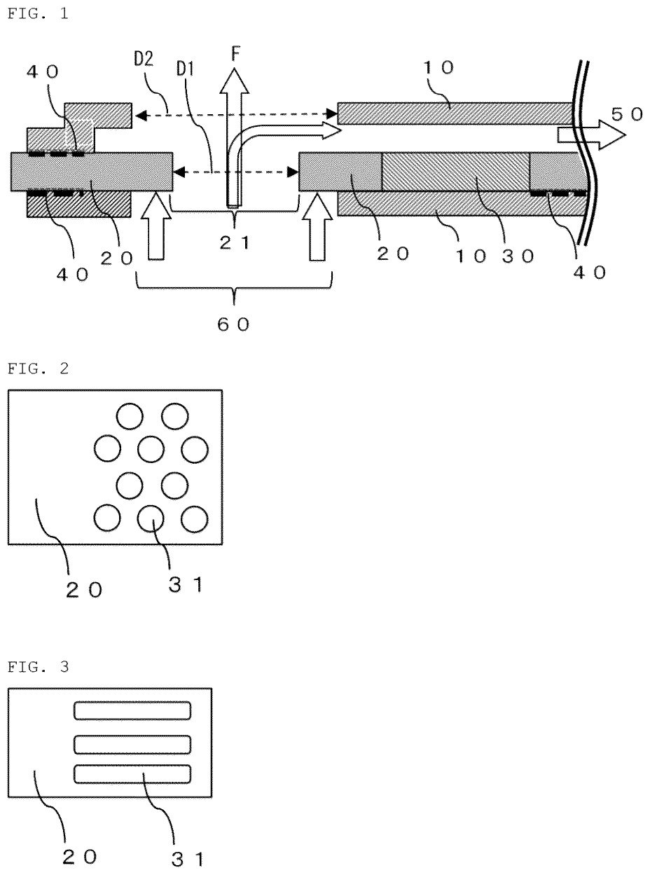

FIG. 1 is a schematic cross-sectional view showing an example of the gas inlet manifold and its periphery of the fuel cell of the present disclosure. In FIG. 1, F represents the flow of gas.

The fuel cell of the present disclosure includes a pair of separators 10 and a resin frame 20 having an adhesive layer on both surfaces thereof.

The pair of separators 10 has at least one manifold 60. The manifold 60 in FIG. 1 shows a gas inlet manifold. In FIG. 1, an example of a gas inlet manifold is shown, but the manifold 60 of the present disclosure is not limited to the case of a gas inlet manifold, and may be a gas outlet manifold.

The pair of separators 10 is adhered to the sealing surface 40 via the resin frame 20.

The resin frame 20 has a manifold opening 21 corresponding to the manifold 60.

The resin frame 20 has a power generation opening corresponding to a power generation unit (not shown) on the power generation unit side 50.

The inner diameter D1 of the manifold opening 21 is smaller than the inner diameter D2 of the manifold 60.

The resin frame 20 has at least one vent 30 between the manifold opening 21 and the power generation opening on the power generation side 50.

FIG. 2 is a schematic plan view showing an example of the resin frame in the gas introduction portion of the fuel cell of the present disclosure.

In the gas introduction portion from the manifold 60 of the resin frame 20, a circular vent hole 31 as shown in FIG. 2 is provided in the resin frame 20. Thus, even if the resin frame 20 is pushed down in the gas flow F direction shown in FIG. 1, the gas flow path is secured by the vent hole 31, it is possible to supply the gas from the manifold 60 to the power generation unit, it is possible to reduce the decrease in the supply amount of gas to the power generation unit.

The circular vent hole 31 is easy to process, can sufficiently secure the gas flow rate, is highly reliable in terms of securing the gas flow rate, and is highly safe from the viewpoint of short circuit prevention.

FIG. 3 is a schematic plan view showing another example of the resin frame in the gas introduction portion of the fuel cell of the present disclosure.

As shown in FIG. 3, the resin frame 20 may be provided with a vent hole 31 having a horizontally long shape. The vent hole 31 having a horizontally long shape can sufficiently secure the gas flow rate, and is highly reliable from the viewpoint of securing the gas flow rate.

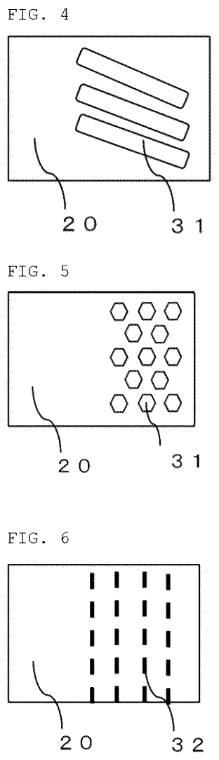

FIG. 4 is a schematic plan view showing another example of the resin frame in the gas introduction portion of the fuel cell of the present disclosure.

As shown in FIG. 4, the resin frame 20 may be provided with an obliquely shaped vent hole 31.

The vent hole 31 having an oblique shape can sufficiently secure the gas flow rate, and is highly reliable from the viewpoint of securing the gas flow rate.

Although not shown, the resin frame 20 may be provided with a vent hole 31 having a longitudinally long shape.

FIG. 5 is a schematic plan view showing another example of the resin frame in the gas introduction portion of the fuel cell of the present disclosure.

As shown in FIG. 5, the resin frame 20 may be provided with a vent hole 31 having a polygonal shape.

The vent hole 31 having a polygonal shape can sufficiently secure the gas flow rate, is highly reliable from the viewpoint of securing the gas flow rate, and is highly safe from the viewpoint of preventing a short circuit.

FIG. 6 is a schematic plan view showing another example of the resin frame in the gas introduction portion of the fuel cell of the present disclosure.

As shown in FIG. 6, the resin frame 20 may be provided with a vertical line cut 32.

The vertical line cut 32 is easy to process.

Although not shown, the resin frame 20 may be provided with a transverse line-shaped cut 32.

The transverse line cut 32 is easy to process and can ensure a sufficient gas flow rate.

When the resin frame 20 is pushed down in the gas flow F direction shown in FIG. 1, the cut 32 is torn by the pushing-down force. As a result, the gas flow path can be secured.

The fuel cell of the present disclosure may have only one unit cell of a fuel cell, or may be a fuel cell stack that is a cell stack in which a plurality of unit cells are stacked.

In the present disclosure, both the unit cell and the fuel cell stack may be referred to as a fuel cell.

The number of stacked unit cells in the fuel cell stack is not particularly limited, and may be, for example, 2 to several hundred.

The unit cell of the fuel cell may include at least a pair of separators and a resin frame, and may include a power generation unit.

The unit cell has a pair of separators.

The pair of separators has at least one manifold.

The manifold may be a gas inlet manifold or a gas outlet manifold. The fuel cell of the present disclosure may include a gas inlet manifold and a gas outlet manifold. The manifold may be a fuel gas manifold or an oxidant gas manifold. The fuel cell of the present disclosure may include a fuel gas manifold and an oxidant gas manifold. The fuel cell of the present disclosure may include a fuel gas inlet manifold, a fuel gas outlet manifold, an oxidant gas inlet manifold, and an oxidant gas outlet manifold.

The pair of separators are adhered to each other via a resin frame.

The separator collects current generated by power generation and functions as a partition wall. In a cell of a fuel cell, the separator is usually disposed on both sides of the power generation unit in the stacking direction so that a pair of separators sandwich the power generation unit. One of the pair of separators is an anode separator and the other is a cathode separator.

The anode separator may have a groove that serves as a fuel gas flow path on a surface on the side of the power generation unit.

The cathode separator may have a groove that serves as an oxidant gas flow path on a surface on the side of the power generation unit.

The separator may be, for example, dense carbon obtained by compressing carbon to make it impermeable to gas, and press-formed metal (for example, iron, aluminum, stainless steel, and the like).

The separator may have holes constituting a manifold such as a supply hole and a discharge hole for allowing a fluid such as a reaction gas and a refrigerant to flow in the stacking direction of the cells.

Examples of the refrigerant include water, a mixed solvent of water and ethylene glycol, and the like.

The resin frame is a three-layer sheet having an adhesive layer on both surfaces.

The resin frame has a manifold opening corresponding to the at least one manifold and a power generation opening corresponding to the power generation unit.

The inner diameter of the manifold opening is smaller than the inner diameter of the manifold.

The resin frame is an insulating resin frame disposed on the outer side (outer periphery) in the surface direction of the membrane electrode assembly between the anode separator and the cathode separator. The resin frame is formed to have a plate shape and a frame shape, and seals between the anode separator and the cathode separator in a condition in which the membrane electrode assembly is held in the power generation opening in the central region.

As the resin frame, for example, resins such as PE, PP, PET, and PEN can be used.

The pressure-sensitive adhesive layer may be, for example, a thermoplastic resin such as a polyester-based resin or a modified olefin-based resin, or may be a thermosetting resin that is a modified epoxy resin.

The resin frame has at least one vent between the manifold opening and the power generation opening. The number of ventilation portions is not particularly limited. The region between the manifold opening and the power generation opening may be a gas inlet or a gas outlet. The gas introduction portion is a region on the gas inlet side that supplies gas from the gas inlet manifold to the power generation portion. The gas outlet is a region on the gas outlet side that discharges gas from the power generation unit to the gas outlet manifold.

The ventilation portion may be capable of venting a gas regardless of whether or not the resin frame is deformed. The vent may be a vent.

The shape of the vent hole is a ventilation portion, circular shape, oblong shape, oblique shape, and may be at least one shape selected from the group consisting of polygonal shape.

The ventilation portion may be capable of venting a gas in a condition where the resin frame is not deformed, and of venting a gas in a state where the resin frame is deformed. The vent may be a linear cut. The linear cut may be a diagonal cut, a vertical line cut, or a transverse line cut.

The shape of the power generation unit may be a rectangular shape in a plan view.

The power generation unit may be a membrane electrode assembly (MEA) including an electrolyte membrane and two electrodes sandwiching the electrolyte membrane.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The two electrodes are one anode (fuel electrode) and the other cathode (oxidant electrode).

The electrode includes a catalytic layer, and may optionally include a gas diffusion layer, and the power generation unit may be a membrane electrode gas diffusion layer assembly (MEGA). In this case, the cell may include a cathode separator, an anode separator, and a membrane electrode gas diffusion layer assembly disposed between the cathode separator and the anode separator.

The membrane electrode gas diffusion layer assembly includes an anode-side gas diffusion layer, an anode catalyst layer, an electrolyte membrane, a cathode catalyst layer, and a cathode-side gas diffusion layer in this order.

The anode catalyst layer and the cathode catalyst layer are collectively referred to as a catalyst layer.

The anode-side gas diffusion layer and the cathode-side gas diffusion layer are collectively referred to as a gas diffusion layer.

The catalyst layer may include a catalyst, and the catalyst may include a catalyst metal that promotes an electrochemical reaction, an electrolyte having proton conductivity, a support having electron conductivity, and the like.

As the catalytic metal, for example, platinum (Pt) and an alloy composed of Pt and another metal (for example, a Pt alloy obtained by mixing cobalt, nickel, and the like) can be used. The catalyst metal used as the cathode catalyst and the catalyst metal used as the anode catalyst may be the same or different.

The electrolyte may be a fluorine-based resin or the like. As the fluorine-based resin, for example, a Nafion solution or the like may be used.

The catalyst metal may be supported on a support, and in each of the catalyst layers, a support (catalyst-supported support) on which the catalyst metal is supported and an electrolyte may be mixed.

Examples of the support for supporting the catalyst metal include carbon materials such as carbon, which are generally commercially available.

The gas-diffusion layer (GDL) may comprise a substrate and a mesoporous layer (MPL).

GDL may include a base material on a side in contact with the separator and a MPL on a side in contact with the catalytic layer.

The base material may be a conductive member or the like having gas permeability.

Examples of the base material include a carbon porous body such as carbon cloth and carbon paper, and a metal porous body such as a metal mesh and a metal foam.

MPL may include a mixture of a water-repellent resin such as PTFE and a conductive material such as carbon black.

MPL may include an antioxidant such as Ce. The generation of radicals can be prevented by an antioxidant.

The fuel cell stack may include a gasket, a resin sheet, and the like between the cells and between the cell stack and the end plate to seal each gas. The resin sheet may be the resin frame described above.

The fuel cell stack may include an end plate disposed at an end of the cell stack. The end plate may be disposed at one end portion in the stacking direction of the cells of the cell stack, or may be disposed at both end portions. The cell stack may be sandwiched between two end plates.

The manifold may be in communication with the cell stack and the end plate.

### REFERENCE SIGNS LIST

10 Separator
20 Resin frame
21 Manifold opening
30 Ventilation section
31 Vent
32 Cut
40 Sealing surface
50 Generator side
60 Manifold
F Gas flow
D1 Inner diameter of manifold opening
D2 Inner diameter of manifold

1. A fuel cell,
wherein the fuel cell comprises at least a pair of separators and a resin frame;
wherein each of the pair of separators has at least one manifold;
wherein the pair of separators are adhered via the resin frame;
wherein the resin frame has an adhesive layer on both sides;
wherein the resin frame has a manifold opening corresponding to the manifold and a power generation opening corresponding to a power generation unit;
wherein an inner diameter of the manifold opening is smaller than that of the manifold; and
wherein the resin frame has at least one ventilation portion between the manifold opening and the power generation opening.

2. The fuel cell according to claim 1,
wherein the ventilation portion is configured to vent a gas regardless of whether or not the resin frame is deformed.

3. The fuel cell according to claim 1,
wherein gas ventilation through the ventilation portion is prevented when the resin frame is in an undeformed state, and gas ventilation through the ventilation portion is allowed when the resin frame is in a deformed state.

4. The fuel cell according to claim 1,
wherein a shape of the ventilation portion is at least one shape selected from the group consisting of a circular shape, a horizontally elongated shape, an oblique shape, a vertically elongated shape, and a polygonal shape.
